(19) United States
(12) Patent Application Publication
(10) Pub. No.: US 2020/0143275 A1
(43) Pub. Date: May 7, 2020

(54) INFORMATION PROCESSING DEVICE, INFORMATION PROCESSING METHOD, AND COMPUTER PROGRAM PRODUCT

(71) Applicant: Kabushiki Kaisha Toshiba, Minato-ku (JP)

(72) Inventors: Yusuke Shirota, Yokohama (JP); Tatsunori Kanai, Yokohama (JP)

(73) Assignee: Kabushiki Kaisha Toshiba, Minato-ku (JP)

(21) Appl. No.: 16/555,233

(22) Filed: Aug. 29, 2019

(30) Foreign Application Priority Data
Nov. 6, 2018 (JP) 2018-208545

(51) Int. Cl. G06N 7/00; G06N 20/00; G06F 12/1027

(52) U.S. Cl. CPC G06N 7/00; G06F 2212/684; G06F 12/1027; G06N 20/00

(57) ABSTRACT

According to an embodiment, an information processing device includes a hardware processor configured to function as: an acquisition unit configured to acquire operation statistical information on a processing circuit; a derivation unit configured to derive a memory access characteristic of the processing circuit from the acquired operation statistical information, based on a prediction model for deriving the memory access characteristic from the operation statistical information; and a determination unit configured to determine an access method from among a first access method and a second access method based on the derived memory access characteristic, the first access method transferring data in a second memory unit to a first memory unit and accessing the data in the first memory unit, the second access method accessing data in the second memory unit, an access speed of the second memory unit from the processing circuit being slower than that of the first memory unit.

### CROSS-REFERENCE TO RELATED APPLICATIONS

This application is based upon and claims the benefit of priority from Japanese Patent Application No. 2018-208545, filed on Nov. 6, 2018; the entire contents of which are incorporated herein by reference.

### FIELD

Embodiments described herein relate generally to an information processing device, an information processing method, and a computer program product.

### BACKGROUND

Various storage class memories (SCMs) such as Magnetoresistive Random Access Memory (MRAM), Resistive RAM (ReRAM), and Phase-Change Memory (PCM) have been developed. The SCM has an access speed lower than that of dynamic random access memories (DRAMs) but has a higher degree of integration. On the other hand, the DRAMs have a degree of integration lower than that of the SCMs but has a higher access speed. Thus, in a system in which a plurality of different types of memories are mounted, these different memories need to be appropriately used.

Conventionally, however, information used to appropriately use different types of memories is not managed, and means for collecting the information is not provided. Thus, it has been conventionally difficult to efficiently provide information used to appropriately use different types of memories. Conventional technologies are described in R. F. Freitas and W. W. Wilcke, “Storage-class Memory: The Next Storage System Technology”, IBM Journal of Research and Development Vol. 52 No. 4, pp. 439-447, 2008.

### BRIEF DESCRIPTION OF THE DRAWINGS

FIG. 1 is a schematic diagram illustrating an example of a configuration of an information processing device;

FIG. 2 is a schematic diagram of a physical address space;

FIG. 3 is a functional block diagram of a processing circuit;

FIG. 4 is an explanatory diagram of learning of a prediction model;

FIG. 5 is an explanatory diagram of a relation between operation statistical information and a memory access characteristic;

FIG. 6A is a schematic diagram of the operation statistical information;

FIG. 6B is a schematic diagram of the memory access characteristic;

FIG. 7 is an explanatory diagram of processing of a derivation unit and a determination unit;

FIG. 8 is an explanatory diagram of determination of an access method;

FIG. 9 is a flowchart of a procedure of information processing; and

FIG. 10 is a flowchart of the procedure of the information processing.

### DETAILED DESCRIPTION

According to an embodiment, an information processing device includes a hardware processor. The hardware processor is configured to function as an acquisition unit, a derivation unit, and a determination unit. The acquisition unit is configured to acquire operation statistical information on a processing circuit. The derivation unit is configured to derive a memory access characteristic of the processing circuit from the acquired operation statistical information, based on a prediction model for deriving the memory access characteristic from the operation statistical information. The determination unit is configured to determine an access method from among a first access method and a second access method based on the derived memory access characteristic. The first access method transfers data in a second memory unit to a first memory unit and accesses the data in the first memory unit. The second access method accesses data in the second memory unit. An access speed of the second memory unit from the processing circuit is slower than that of the first memory unit.

Details of the present embodiment are described below with reference to the accompanying drawings.

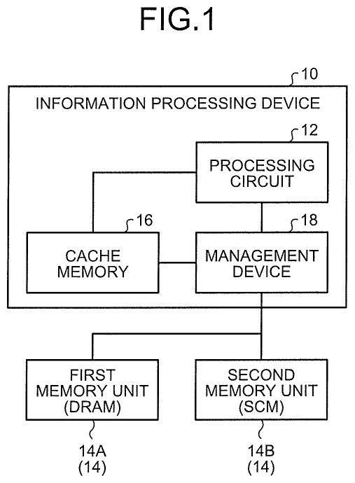

FIG. 1 is a schematic diagram illustrating an example of a configuration of an information processing device 10 according to the present embodiment. The information processing device 10 includes a processing circuit 12, a cache memory 16, and a management device 18. Storage units 14 are connected to a memory bus of the information processing device 10.

The processing circuit 12 and the cache memory 16, the processing circuit 12 and the management device 18, and the cache memory 16 and the management device 18 are connected so as to transmit and receive data and signals. The processing circuit 12, the management device 18, and the storage units 14 are connected so as to transmit and receive data and signals.

The processing circuit 12 has one or more processors. The processor is, for example, a central processing unit (CPU). The processor may include one or more CPU cores. The processing circuit 12 reads data from the storage unit 14 and writes data in the storage unit 14 through the management device 18 in response to the execution of one or more application programs.

In the following, application programs are sometimes simply referred to as “applications”. The reading of data from the storage unit 14 and the writing of data in the storage unit 14 are sometimes collectively referred to as “access to the storage unit 14”.

The processing circuit 12 and the management device 18 temporarily store data stored in the storage unit 14 in the cache memory 16, and use the data for processing.

The storage unit 14 is a main memory used as a working area for the processing circuit 12. The information processing device 10 in the present embodiment includes a plurality of different types of storage units 14. In other words, the information processing device 10 in the present embodiment uses the different types of storage units 14 as main memories.

The access speeds of the different types of storage units 14 from the processing circuit 12 are different from each other. In the following, the access speed from the processing circuit 12 is sometimes simply referred to as “access speed”. The access speed is sometimes called “access delay”. A high access speed means a short access delay time.

In the present embodiment, the information processing device 10 includes a first memory unit 14A and a second memory unit 14B as the different types of storage units 14 having different access speeds. The information processing device 10 may include three or more types of storage units 14.

The access speed of the first memory unit 14A is higher than that of the second memory unit 14B. In the present embodiment, the first memory unit 14A has a degree of integration lower than that of the second memory unit 14B.

The first memory unit 14A is, for example, a volatile memory. Specifically, the first memory unit 14A is a dynamic random access memory (DRAM). The first memory unit 14A may be a non-volatile memory such as a magnetoresistive random access memory (MRAM), which can be accessed at high speed comparable with DRAMs.

On the other hand, the access speed of the second memory unit 14B is lower than that of the first memory unit 14A. In the present embodiment, the second memory unit 14B has a degree of integration higher than that of the first memory unit 14A. In other words, the second memory unit 14B has a capacity larger than that of the first memory unit 14A.

The second memory unit 14B is, for example, a non-volatile memory. Specifically, the second memory unit 14B is a large-capacity high-speed non-volatile memory having a capacity larger than that of a DRAM.

Further specific examples of the second memory unit 14B include an MRAM, a phase change memory (PCM), a phase random access memory (PRAM), a phase change random access memory (PCRAM), a resistance change random access memory (ReRAM), a ferroelectric random access memory (FeRAM), 3DXPoint, and a memristor.

The second memory unit 14B may be a memory what is called “storage class memory (SCM)”. The second memory unit 14B may be a module in which a plurality of semiconductor devices are provided on one substrate or casing.

In the present embodiment, the case where the first memory unit 14A is a DRAM and the second memory unit 14B is an SCM is described as an example. The access speed of the first memory unit 14A only needs to be higher than that of the second memory unit 14B, and a combination of the first memory unit 14A and the second memory unit 14B is not limited to a DRAM as the first memory unit 14A and an SCM as the second memory unit 14B. For example, the first memory unit 14A may be an MRAM and the second memory unit 14B may be a ReRAM.

When the first memory unit 14A and the second memory unit 14B are collectively described, these storage units are simply referred to as “storage unit 14”.

The storage unit 14 includes a plurality of first areas. The first area includes a plurality of second areas. In other words, in the present embodiment, the processing circuit 12 and the management device 18 manage the first memory unit 14A and the second memory unit 14B for each first area and for each second area in the first area.

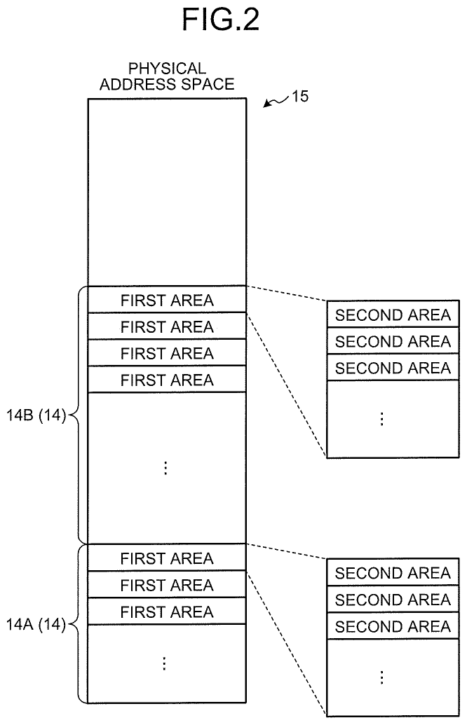

FIG. 2 is a schematic diagram illustrating a physical address space seen from the processing circuit 12.

As illustrated in FIG. 2, the first memory unit 14A and the second memory unit 14B each include the first areas.

The first area is, for example, a unit of data managed by the processing circuit 12 or a unit of data (for example, page) managed by an operating system running on the processing circuit 12. For example, the page is 4 KB. In other words, the first area is a transfer unit of data transferred between the first memory unit 14A and the second memory unit 14B. The first area may be a unit of a predetermined multiple of the unit of data managed by the processing circuit 12. In the present embodiment, the case where the first area corresponds to a page is described as an example.

The second area is an area smaller than the first area. For example, the second area is a rewriting unit of data associated with access to the storage unit 14 by the processing circuit 12. In other words, the second area is a unit of data accessed by the processing circuit 12. Specifically, the second area is a unit called “cache line”. The cache line corresponds to a unit of data to be rewritten in the cache memory 16. In other words, the management device 18 that has received a memory access request from the processing circuit 12 accesses the first memory unit 14A or the second memory unit 14B in units of the cache line.

The cache line is, for example, 64 bytes. The second area may be a unit (for example, byte unit) smaller than the cache line. The second area may be a unit of a predetermined multiple of the size of the cache line.

In the present embodiment, the processing circuit 12 and the management device 18 partition the areas in the first memory unit 14A and the second memory unit 14B mapped in a physical address space 15 illustrated in FIG. 2 into the size (for example, page size) of the first area, and manage the areas. The processing circuit 12 and the management device 18 use a page table to convert logical addresses into physical addresses to implement virtual memory.

Referring back to FIG. 1, the description is continued. The management device 18 manages access to the different types of storage units 14 (first memory unit 14A and second memory unit 14B) by the processing circuit 12. The management device 18 is sometimes called “memory management unit (MMU)”. The management device 18 may be a memory controller.

The management device 18 processes a memory access request received from the processing circuit 12. The memory access request is a request of access to the storage unit 14 from the processing circuit 12. The memory access request indicates data writing to the storage unit 14 or data reading from the storage unit 14. The memory access request includes address information on a first area and address information on a second area in the storage unit 14 to be accessed. The address information is represented by logical addresses.

The management device 18 accesses the storage unit 14 when data to be accessed indicated by the memory access request received from the processing circuit 12 is not stored in the cache memory 16. In this case, the management device 18 accesses a second area in the first area in the storage unit 14 to be accessed, which is indicated by the memory access request received from the processing circuit 12. The management device 18 executes processing (writing or reading) indicated by the memory access request on the accessed second area.

Specifically, the memory access request received from the processing circuit 12 may indicate writing in a particular second area. In this case, the management device 18 writes data indicated by the memory access request in a second area in a first area to be accessed in the storage unit 14 to be accessed, which is indicated by the memory access request. The memory access request received from the processing circuit 12 may indicate data reading from a particular second area. In this case, the management device 18 reads data from a second area in a first area to be accessed in the storage unit 14 to be accessed, which is indicated by the memory access request, and stores the read data in the cache memory 16 and outputs the data to the processing circuit 12.

Next, the processing circuit 12 is described in detail. As described above, the processing circuit 12 accesses the storage unit 14 through the management device 18 in response to the execution of one or more applications.

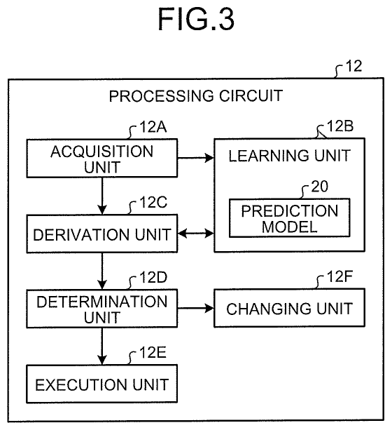

FIG. 3 is an example of a functional block diagram of the processing circuit 12. The processing circuit 12 includes an acquisition unit 12A, a learning unit 12B, a derivation unit 12C, a determination unit 12D, an execution unit 12E, and a changing unit 12F.

At least one of the acquisition unit 12A, the learning unit 12B, the derivation unit 12C, the determination unit 12D, the execution unit 12E, and the changing unit 12F may be implemented by causing a processor such as a CPU to execute a computer program, that is, by software. At least one of the acquisition unit 12A, the learning unit 12B, the derivation unit 12C, the determination unit 12D, the execution unit 12E, and the changing unit 12F may be implemented by dedicated hardware such as an integrated circuit (IC). At least one of the acquisition unit 12A, the learning unit 12B, the derivation unit 12C, the determination unit 12D, the execution unit 12E, and the changing unit 12F may be implemented by a combination of software and hardware. When processors are used, each processor may implement one of the acquisition unit 12A, the learning unit 12B, the derivation unit 12C, the determination unit 12D, the execution unit 12E, and the changing unit 12F, or may implement two or more of the units.

The acquisition unit 12A acquires operation statistical information on the processing circuit 12.

The operation statistical information is a statistical value of information on operation of the processing circuit 12. Specifically, the operation statistical information is a statistical value of information on operation when the processing circuit 12 executes one or more applications. The statistical value of information on the operation indicates information on the operation per unit period T. The unit period T may be set in advance. The operation statistical information may be a statistical value of information on operation of the management device 18, the cache memory 16, or the information processing device 10. For example, the operation statistical information is collected by a performance counter included in the processor and configured to measure hardware events. For example, the operation statistical information may be overall information indicating the state of the information processing device or the internal state of an OS managed by the OS (for example, statistical information on the number of times of event occurrence in the OS).

Specifically, the operation statistical information is represented by one or more hardware events collected by the performance counter per unit period T, such as the number of translation lookaside buffer (TLB) misses, operation statistical information related to a TLB miss, the number of cache misses in each tier (such as L1 cache, L2 cache, L3 cache, and last level cache (LLC)) of the cache memory, operation statistical information related to a cache miss, the number of times of writing in the storage unit 14, the number of times of reading from the storage unit 14, the number of secondary level TLB (STLB) misses, and operation statistical information related to an STLB miss. The operation statistical information may further include a physical memory size allocated to an application executed in an execution period concerned in the execution period, which is managed by an OS, (that is, the size of a memory that can be accessed at any timing during execution of an application). The operation statistical information is not limited to the above.

The acquisition unit 12A mayo acquire operation statistical information on the processing circuit 12 by a publicly known method. For example, the acquisition unit 12A only needs to sequentially acquire operation statistical information for each unit period T from a performance counter provided in the processing circuit 12. Examples of the performance counter include a performance monitoring counter of an Intel processor, but the performance counter is not limited thereto. The acquisition unit 12A may be formed integrally with the performance counter. The acquisition unit 12A and the performance counter may be formed separately. In the present embodiment, the configuration in which the acquisition unit 12A and the performance counter are formed separately is described as an example.

The learning unit 12B learns a prediction model 20 by using a training data set including a plurality of pieces of training data.

The prediction model 20 is a model for deriving a memory access characteristic from operation statistical information. The prediction model 20 is a learning model generated by learning.

The memory access characteristic indicates a characteristic of access to the first memory unit 14A and the second memory unit 14B by the processing circuit 12.

For example, the memory access characteristic is represented by a memory size used by the processing circuit 12 per unit period T during the execution of an application. Specifically, for example, when the processing circuit 12 issues a load instruction and a store instruction to data on the storage unit 14 or the cache memory 16 per unit period T during the execution of an application, the memory access characteristic is a total size of the data. Specifically, it is assumed that N pages are accessed per unit period T (N is an integer of 1 or more) while the processing circuit 12 is executing an application. In this case, when the capacity of 1 page is 4 K bytes, the memory access characteristic is represented by the result (N×4 K) of multiplying “N” by “4 K bytes”, which is the capacity of 1 page. This is sometimes generally called “working set size”. The memory size may be expressed by the number of pages (number of first areas) for storing therein data accessed to the storage unit 14 or the cache memory 16 for caching data in the storage unit 14 by the processing circuit 12.

The learning unit 12B uses the training data set to learn a prediction model 20 that inputs operation statistical information and outputs a memory access characteristic.

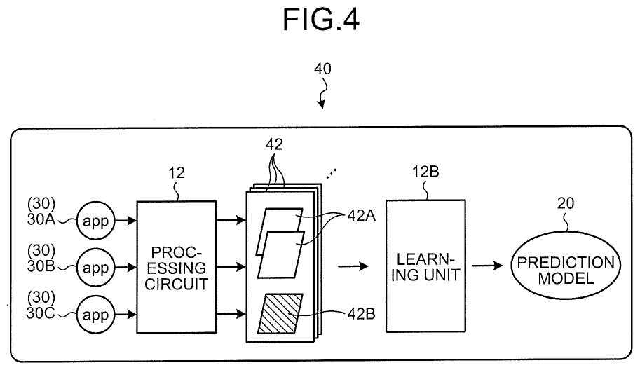

FIG. 4 is an explanatory diagram of learning of the prediction model 20. A training data set 40 includes a plurality of pieces of training data 42. The training data 42 is generated for each unit period T. The training data 42 includes operation statistical information 42A and a memory access characteristic 42B. Each piece of the training data 42 includes one or more pieces of operation statistical information 42A. Each piece of the training data 42 includes one memory access characteristic 42B as a piece of answer information corresponding to one or more pieces of operation statistical information 42A.

The processing circuit 12 prepares the training data set 40 in advance. For example, the processing circuit 12 executes one or more applications 30 for learning (for example, an application 30A, an application 30B, and an application 30C). The processing circuit 12 generates, for each unit period T, the training data 42 made up of a pair of one or more pieces of operation statistical information 42A and a memory access characteristic 42B during the execution of the application 30. By this processing, the processing circuit 12 prepares the training data set 40 including the pieces of training data 42 in advance.

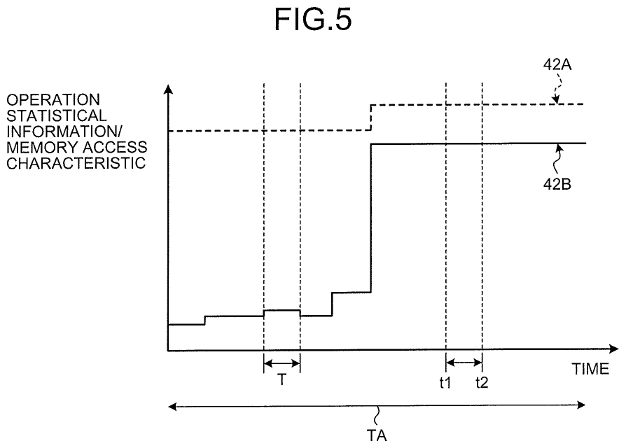

FIG. 5 is an explanatory diagram illustrating an example of the relation between the operation statistical information 42A and the memory access characteristic 42B in an execution period TA of the learning application 30. The vertical axis of the graph illustrated in FIG. 5 indicates the operation statistical information or the memory access characteristic. The horizontal axis of the graph illustrated in FIG. 5 indicates time. In FIG. 5, the case where the operation statistical information 42A indicates a physical memory size allocated to the running application and the memory access characteristic 42B indicate a memory size used by the processing circuit 12 per unit period T during the execution of the application is illustrated as an example.

It is assumed that a transition over time of the operation statistical information 42A and the memory access characteristic 42B when the processing circuit 12 executes the learning application 30 indicates the transition illustrated in FIG. 5. In this case, the learning unit 12B only needs to generate the correspondence between the operation statistical information 42A and the memory access characteristic 42B for each unit period T as the training data 42 for each unit period T. Unit periods T of the training data 42 at adjacent timings may be timings at which the unit periods T partially overlap or timings at which the unit periods T do not overlap.

The learning unit 12B only needs to acquire the operation statistical information 42A for each unit period T from the performance counter through the acquisition unit 12A, and use the acquired operation statistical information 42A to generate the training data 42 in the unit period T.

The learning unit 12B only needs to acquire the memory access characteristic 42B for each unit period T used for the training data 42 by the following method.

Specifically, the learning unit 12B resets, at the first timing (for example, t1) in the unit period T, a part of a page table managed by an operating system (OS) installed on the processing circuit 12 in advance. Specifically, the learning unit 12B resets the page table by setting accessed flags of all pages in the page table to “0” meaning “unaccessed”. Next, the learning unit 12B counts, at the finish timing (for example, t2) of the section in the unit period T, the number of accessed flags (flag of “1”) in the page table. By this counting processing, the learning unit 12B determines the number of pages accessed by the processing circuit 12 in the unit period T. The learning unit 12B acquires the result (N×4 K) of multiplying the number of pages (N) by “4 K bytes”, which is the capacity of 1 page, as a memory access characteristic 42B in the unit period T.

The learning unit 12B executes the above-mentioned processing for each unit period T. The learning unit 12B generates training data 42 indicating the correspondence between the operation statistical information 42A and the memory access characteristic 42B acquired for each unit period T.

As described above, the learning unit 12B acquires the operation statistical information 42A from the performance counter through the acquisition unit 12A. Thus, the learning unit 12B can acquire the operation statistical information 42A in real time during the execution of the learning application 30. On the other hand, the learning unit 12B needs to execute the processing such as resetting the page table, counting the number of accessed flags, and calculating the memory access characteristic 42B for each unit period T in order to acquire the memory access characteristic 42B. Thus, it is sometimes difficult for the learning unit 12B to acquire the memory access characteristic 42B in real time during the execution of the learning application 30. The processing such as resetting the page table, counting the number of accessed flags, and counting the memory access characteristic 42B itself may affect the operation statistical information 42A (the operation statistical information 42A may greatly change from that when only an application is executed), and hence it is desired to avoid this situation.

In view of this, in the present embodiment, the processing circuit 12 executes the learning application 30 twice. The learning unit 12B acquires operation statistical information 42A during one of the first time of execution and the second time of execution of the application 30, and acquires a memory access characteristic 42B during the other time of execution of the application 30. The learning unit 12B generates training data 42 indicating the correspondence between the operation statistical information 42A and the memory access characteristic 42B for each instruction unit of the application 30 corresponding to the unit period T.

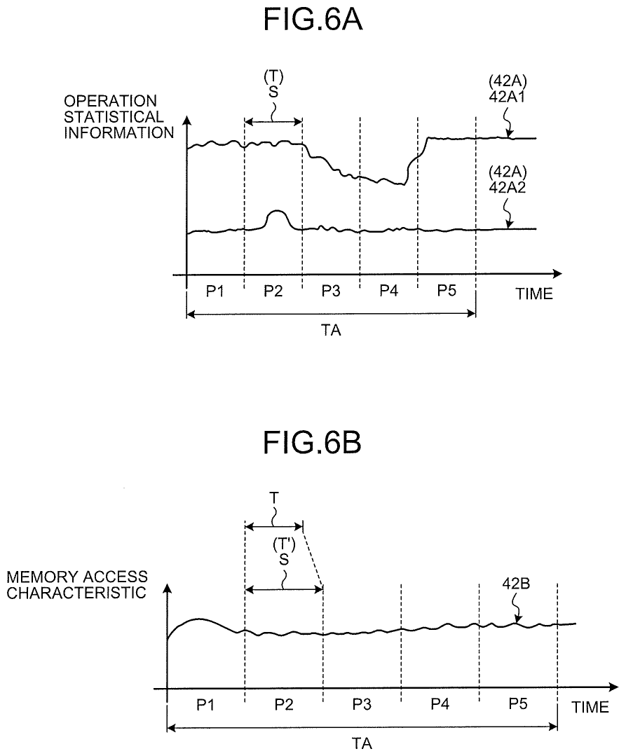

FIG. 6A is a schematic diagram illustrating an example of the operation statistical information 42A when the learning application 30 is executed. In FIG. 6A, as the operation statistical information 42A, operation statistical information 42A1 related to a TLB miss and physical memory size 42A2 allocated to a running application are illustrated as an example. The vertical axis of the graph illustrated in FIG. 6A indicates the operation statistical information, and the horizontal axis indicates time.

As illustrated in FIG. 6A, it is assumed that a transition of the operation statistical information 42A over time when the processing circuit 12 executes the learning application 30 indicates the transition illustrated in FIG. 6A. The learning unit 12B defines a unit period T as a period during which the application 30 executes an instruction unit S. For example, the instruction unit S is 100,000 times. The number of instructions in the instruction unit S only needs to be set in advance, and is not limited to 100,000 times.

In this case, the learning unit 12B acquires the operation statistical information 42A for each instruction unit S (that is, for each unit period T) by acquiring the operation statistical information 42A for each instruction unit S of the application 30 from the performance counter. For example, it is assumed that a period TA during which the learning application 30 is executed is managed while being divided into a phase P1, a phase P2, a phase P3, a phase P4, and a phase P5 from the past to the future for each instruction unit S. In this case, the learning unit 12B acquires operation statistical information 42A in each of the phases (phase P1 to phase P5).

Next, the learning unit 12B executes the same learning application 30 again to acquire a memory access characteristic 42B for each instruction unit S.

FIG. 6B is a schematic diagram illustrating an example of the memory access characteristic 42B when the same learning application 30 as that used to acquire the operation statistical information 42A for training data 42 is executed. In FIG. 6B, as the memory access characteristic 42B, a memory size used by the processing circuit 12 per unit period T is illustrated as an example. The vertical axis of the graph illustrated in FIG. 6B indicates the memory access characteristic, and the horizontal axis indicates time.

The learning unit 12B executes, for each instruction unit S corresponding to a unit period T, the resetting of the page table, the counting of the number of accessed flags, and the calculation of the memory access characteristic 42B. By this processing, the learning unit 12B acquires the memory access characteristic 42B for each instruction unit S. Thus, the learning unit 12B acquires the memory access characteristic 42B for each instruction unit S in each of the phases (phase P1 to phase P5).

The learning unit 12B only needs to generate training data 42 indicating the correspondence between the operation statistical information 42A and the memory access characteristic 42B for each instruction unit S of the learning application 30.

The learning unit 12B executes, for each instruction unit S, the resetting of the page table, the counting of the number of accessed flags, and the calculation of the memory access characteristic 42B, and hence the time required for the execution may be a period T′ longer than the unit period T.

However, in the present embodiment, the learning unit 12B acquires the memory access characteristic 42B for each instruction unit S with reference to an instruction unit S corresponding to a unit period T when the operation statistical information 42A is acquired in real time. Thus, the learning unit 12B can accurately generate training data 42 indicating the correspondence between the operation statistical information 42A and the memory access characteristic 42B for each unit period T when the processing circuit 12 actually executes the application 30.

Referring back to FIG. 4, the description is continued. The learning unit 12B uses the training data set 40 including the pieces of training data 42 to learn a prediction model 20 for deriving the memory access characteristic 42B from the operation statistical information 42A.

The learning unit 12B only needs to learn the prediction model 20 by using a publicly known learning algorithm. Examples of the learning algorithm include linear regression, the K-nearest neighbor algorithm (KNN), support-vector machines, and random forests. However, the algorithm is not limited thereto.

The learning unit 12B only needs to learn the prediction model 20 by using the pieces of training data 42 included in the training data set 40 at each predetermined timing. For example, the learning unit 12B may learn the prediction model 20 each time new training data 42 is registered in the training data set 40. The registration of the training data 42 only needs to be executed at desired timing.

When the learning unit 12B learns a new prediction model 20 by using the training data set 40 including new training data 42, the learning unit 12B only needs to update the prediction model 20 registered in the learning unit 12B with the newly learned prediction model 20. In other words, one prediction model 20 is stored in the learning unit 12B.

Referring back to FIG. 3, the description is continued. Next, the derivation unit 12C is described.

The derivation unit 12C derives, based on a prediction model 20 learned by the learning unit 12B, memory access characteristic 42B from the operation statistical information 42A acquired by the acquisition unit 12A. The operation statistical information 42A used by the derivation unit 12C to derive the memory access characteristic 42B is different from that used by the learning unit 12B to learn the prediction model 20, but is operation statistical information 42A obtained when the processing circuit 12 executes an actual application 30 other than the learning application. The derivation unit 12C uses the operation statistical information 42A and the prediction model 20 to derive the memory access characteristic 42B.

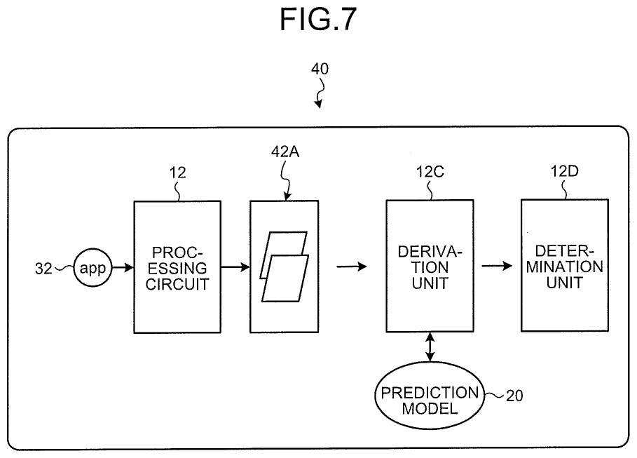

FIG. 7 is an explanatory diagram of an example of processing by the derivation unit 12C and the determination unit 12D.

For example, the derivation unit 12C acquires, from the acquisition unit 12A, the operation statistical information 42A when the processing circuit 12 is executing an application 32 to be optimized. The derivation unit 12C inputs the acquired operation statistical information 42A to the prediction model 20 to obtain memory access characteristic 42B as the output from the prediction model 20.

In other words, the derivation unit 12C uses the prediction model 20 to obtain a predicted value of the memory access characteristic 42B with respect to the operation statistical information 42A acquired by the acquisition unit 12A.

The determination unit 12D determines an access method based on the memory access characteristic 42B derived by the derivation unit 12C.

The access method indicates a method of accessing the storage unit 14 by the processing circuit 12. In the present embodiment, the access method indicates a first access method or a second access method.

The first access method is an access method for transferring data in the second memory unit 14B to the first memory unit 14A and accessing the data in the first memory unit 14A. Data to be transferred and accessed is data that was accessed by the processing circuit 12 when the operation statistical information 42A used to determine the access method was obtained. In other words, the data to be transferred and accessed is data that was accessed by the processing circuit 12 when operation indicated by the operation statistical information 42A used to determine the access method was executed.

In the present embodiment, the transfer means copying. As described above, the processing circuit 12 transfers data in units of pages (units of first areas). The processing circuit 12 accesses the storage unit 14 in units of cache lines (second areas).

Thus, the first access method indicates that data in a page (first area) including data that was accessed by the processing circuit 12 during the execution of operation indicated by the operation statistical information 42A used to determine the access method is transferred from the second memory unit 14B to the first memory unit 14A, and the transferred data in the first memory unit 14A is accessed.

The second access method is a method for accessing data in the second memory unit 14B. In the present embodiment, the processing circuit 12 accesses data in the second memory unit 14B in principle. Only when particular conditions are satisfied, the processing circuit 12 transfers data from the second memory unit 14B to the first memory unit 14A, and accesses the data in the first memory unit 14A. Thus, the second access method indicates that the second memory unit 14B is directly accessed while data is still arranged in the second memory unit 14B.

For example, the determination unit 12D chooses the second access method when the memory access characteristic 42B derived by the derivation unit 12C are larger than a first threshold. The determination unit 12D chooses the first access method when the memory access characteristic 42B are equal to or smaller than the first threshold.

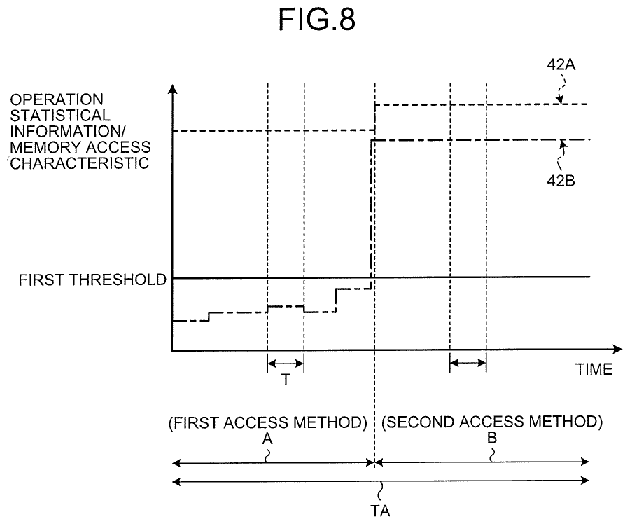

FIG. 8 is an explanatory diagram of determination of the access method. The horizontal axis in FIG. 8 indicates time, and the vertical axis indicates the operation statistical information 42A.

For example, it is assumed that the derivation unit 12C inputs the operation statistical information 42A acquired by the acquisition unit 12A during the execution of the application 32 to the prediction model 20 to derive the memory access characteristic 42B illustrated in FIG. 8.

It is assumed that the operation statistical information 42A indicates a physical memory size allocated to an application running on the processing circuit 12. It is assumed that the memory access characteristic 42B indicates a memory size used by the processing circuit 12 (application 32) per unit period T during the execution of the application 32.

In this case, the determination unit 12D chooses the second access method when the derived memory access characteristic 42B are larger than the first threshold. The determination unit 12D chooses the first access method when the derived memory access characteristic 42B are equal to or smaller than the first threshold.

As illustrated in FIG. 8, the determination unit 12D chooses the first access method when the memory access characteristic 42B are equal to or smaller than the first threshold as in a first-half period A of an execution period TA of the application 32.

In other words, the determination unit 12D estimates the state in which the memory access characteristic 42B are equal to or smaller than the first threshold as a state in which memory access by the processing circuit 12 concentrates and the locality of access is high. The determination unit 12D chooses the first access method when the memory access characteristic 42B are equal to or smaller than the first threshold.

Thus, when the processing circuit 12 accesses data having high access locality, that is, when the location of memory access in the storage unit 14 concentrates, the determination unit 12D can determine an access method such that data is transferred from the second memory unit 14B to the first memory unit 14A and the processing circuit 12 accesses data on the first memory unit 14A in units of cache lines.

On the other hand, the determination unit 12D chooses the second access method when the memory access characteristic 42B exceed the first threshold as in a second-half period B of the execution period TA of the application 32.

As illustrated in FIG. 8, the determination unit 12D chooses the second access method when the memory access characteristic 42B exceed the first threshold as in the second-half period B of the execution period TA of the application 32.

In other words, the determination unit 12D estimates the state in which the memory access characteristic 42B exceed the first threshold to be the state in which the memory access by the processing circuit 12 is distributed, the locality of access is low, and the used memory size is large. The determination unit 12D chooses the second access method when the memory access characteristic 42B exceed the first threshold.

When the memory access characteristic 42B exceed the first threshold, by choosing the second access method, the determination unit 12D can increase the speed of memory access by the processing circuit 12.

When the memory access characteristic 42B exceed the first threshold, even if data in the second memory unit 14B is transferred to the first memory unit 14A, the data is immediately transferred from the first memory unit 14A to the second memory unit 14B due to an insufficient free capacity of the first memory unit 14A. In other words, when the memory access characteristic 42B exceed the first threshold, if data in the second memory unit 14B is transferred to the first memory unit 14A, data is frequently exchanged between the first memory unit 14A and the second memory unit 14B in units of pages, which may cause reduction in performance of the processing circuit 12.

In view of this, in the present embodiment, the determination unit 12D chooses the second access method when the memory access characteristic 42B exceed the first threshold. Thus, the determination unit 12D can increase the speed of memory access by the processing circuit 12.

As the first threshold, a desired value can be freely determined in advance. For example, the first threshold only needs to be the size of the first memory unit 14A available to the processing circuit 12, or a value close thereto.

Specific examples of the size available to the processing circuit 12 include a size of the first memory unit 14A available to an application 32 executed by the processing circuit 12 and a size of the storage unit 14 available to the information processing device 10. The first threshold may be a value larger than these available sizes by a predetermined proportion. The first threshold may be a value smaller than these available sizes by a predetermined proportion.

By setting the first threshold to a value larger than the size of the first memory unit 14A available to the application 32 executed by the processing circuit 12 or a value larger than the size of the first memory unit 14A available to the information processing device 10, the following effects are obtained. For example, the first memory unit assumes a high-speed SCM, and hence data can be transferred between the first memory unit 14A and the second memory unit 14B at high speed when the first access method is chosen. In other words, even when data transfer from the second memory unit 14B to the first memory unit 14A or data transfer from the first memory unit 14A to the second memory unit 14B is positively performed to exchange data frequently, the speed reduction is small and the data can be processed at high speed. Thus, in terms of the maximum utilization of the available first memory unit 14A, by setting the first threshold to a value larger than the size of the available first memory unit 14A, the available first memory unit 14A can be utilized at a maximum, and an application using a larger memory size can be executed. In terms of the reduction of the available first memory unit 14A, by setting the first threshold to a value larger than the size of the available first memory unit 14A, efficient processing with a small use memory size (that is, low power consumption) and suppressed speed reduction can be executed by a size smaller than the size of the actually available first memory unit 14A.

Referring back to FIG. 3, the description is continued. Next, the execution unit 12E is described. The execution unit 12E executes, in accordance with the access method determined by the determination unit 12D, transfer of data from the second memory unit 14B to the first memory unit 14A and access to the data in the first memory unit 14A, or access to data in the second memory unit 14B.

In other words, when the determination unit 12D chooses the first access method, the execution unit 12E transfers a page (first area) including data that was accessed by the processing circuit 12 during the execution of operation indicated by the operation statistical information 42A used to determine the access method from the second memory unit 14B to the first memory unit 14A, and executes access to the data in the transferred page in the first memory unit 14A.

Timing of the data transfer from the first memory unit 14A to the second memory unit 14B by the execution unit 12E is not limited. For example, the execution unit 12E may transfer data at any of the timing immediately after the determination unit 12D chooses the first access method, the timing at which the execution unit 12E accesses the data next, and the timing satisfying a predetermined condition. Examples of the timing satisfying the predetermined condition include a period during which memory access to the storage unit 14 by the processing circuit 12 is equal to or smaller than a predetermined value.

On the other hand, when the determination unit 12D chooses the second access method, the execution unit 12E continues to execute access to data in the second memory unit 14B that was accessed by the processing circuit 12 during the execution of the operation indicated by the operation statistical information 42A used to determine the access method.

Next, the changing unit 12F is described. When the determination unit 12D determines the first access method, the changing unit 12F changes the available memory size of the first memory unit 14A.

Specifically, the changing unit 12F changes the available memory size of the first memory unit 14A to a memory size used by the processing circuit 12 per unit period T during the execution of the application 32, which is indicated by the memory access characteristic 42B used to choose the first access method. The changing unit 12F changes the available memory size of the first memory unit 14A to a size larger than the used memory size by a predetermined proportion or a size smaller than the used memory size by a predetermined proportion. The changing unit 12F only needs to set an unavailable area in the first memory unit 14A after the available memory size is changed to power-off or a low power consumption mode such as a self-refresh mode.

The processing circuit 12 is not necessarily required to include the changing unit 12F. In other words, the processing circuit 12 is not necessarily required to change the available memory size in the first memory unit 14A.

Next, an example of a procedure of information processing executed by the processing circuit 12 in the present embodiment is described.

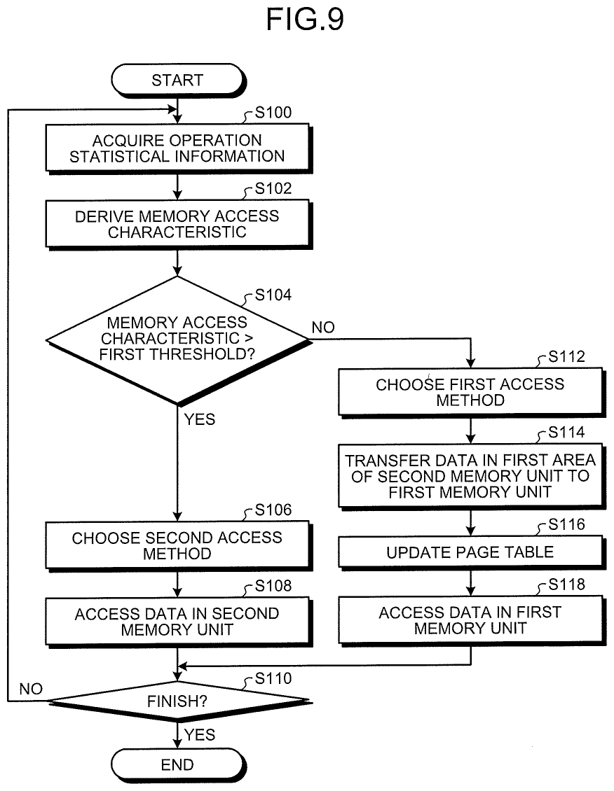

FIG. 9 is a flowchart illustrating an example of the procedure of the information processing executed by the processing circuit 12 in the present embodiment. The description is given on the assumption that the learning unit 12B has already learned a prediction model 20 before the procedure of the information processing illustrated in FIG. 9 is executed. In FIG. 9, the configuration in which the changing unit 12F does not execute processing for changing the available memory size of the first memory unit 14A is illustrated as an example.

First, the acquisition unit 12A acquires operation statistical information 42A on the processing circuit 12 in a unit period T (Step S100).

Next, the derivation unit 12C inputs the operation statistical information 42A acquired at Step S100 to the prediction model 20 learned by the learning unit 12B to derive a memory access characteristic 42B (Step S102).

Next, the determination unit 12D determines whether the memory access characteristic 42B derived at Step S102 are larger than a first threshold (Step S104).

When the determination unit 12D determines that the memory access characteristic 42B are larger than the first threshold (Yes at Step S104), the flow proceeds to Step S106.

At Step S106, the determination unit 12D chooses a second access method (Step S106). Next, the execution unit 12E accesses the second memory unit 14B while data in the second memory unit 14B that is being accessed by the processing circuit 12 during the execution of processing indicated by the operation statistical information 42A acquired at Step S100 is still arranged in the second memory unit 14B (Step S108).

Next, the processing circuit 12 determines whether to finish the information processing (Step S110). For example, the processing circuit 12 performs the determination at Step S110 by determining whether an instruction to finish an application 32 executing the processing indicated by the operation statistical information 42A acquired at Step S100 has been received. When positive determination is made at Step S110 (Yes at Step S110), this routine is finished. On the other hand, when negative determination is made at Step S110 (No at Step S110), the flow returns to Step S100 described above.

On the other hand, when the determination unit 12D determines at Step S104 described above that the memory access characteristic 42B derived at Step S102 are equal to or smaller than the first threshold (No at Step S104), the flow proceeds to Step S112.

At Step S112, the determination unit 12D chooses a first access method (Step PS112). Next, the execution unit 12E transfers data in a first area (page) of the second memory unit 14B that was accessed by the processing circuit 12 during the execution of operation indicated by the operation statistical information 42A acquired at Step S100 from the second memory unit 14B to the first memory unit 14A (Step S114).

Next, the execution unit 12E updates, in the page table, a physical address corresponding to a logical address of the first area to which the data has been transferred at Step S114 with a physical address indicating the storage destination of the first memory unit 14A to which the data was transferred at Step S114 (Step S116). Thus, when accessing the data, the processing circuit 12 can access the data by accessing the first memory unit 14A.

The execution unit 12E accesses the data transferred to the first memory unit 14A at Step S114 (Step S118). The flow proceeds to Step S110 described above.

As described above, the information processing device 10 in the present embodiment includes the acquisition unit 12A, the derivation unit 12C, and the determination unit 12D. The acquisition unit 12A acquires operation statistical information 42A on the processing circuit 12. The derivation unit 12C derives, based on a prediction model 20 for deriving a memory access characteristic 42B of the processing circuit 12 from the operation statistical information 42A, the memory access characteristic 42B from the acquired operation statistical information 42A. Based on the derived memory access characteristic 42B, the determination unit 12D determines any one of the first access method for transferring data in the second memory unit 14B, which is accessed by the processing circuit 12 at a speed slower than that of accessing the first memory unit 14A, to the first memory unit 14A and accessing the data in the first memory unit 14A, and the second access method for accessing data in the second memory unit 14B.

In this manner, the information processing device 10 in the present embodiment determines any one of the first access method and the first access method based on the prediction model 20.

Conventionally, it has been difficult to efficiently provide information used to appropriately use a plurality of different types of memories (storage units 14).

The second memory unit 14B such as an SCM has a capacity larger than that of the first memory unit 14A such as a DRAM, but has a slower access speed. Thus, when data is distributed and stored in the first memory unit 14A and the second memory unit 14B and accessed depending on characteristics of data to be processed, the processing circuit 12 can efficiently execute data processing. In other words, when the locality of access by the processing circuit 12 is low and the locations of memory access are widely distributed such that the size of data to be accessed is large, it is preferred that the processing circuit 12 directly access the second memory unit 14B while data is still arranged in the second memory unit 14B. When the locations of memory access concentrate and the processing circuit 12 accesses data having high access locality, it is preferred that data be transferred (copied) from the second memory unit 14B to the first memory unit 14A and the processing circuit 12 access data on the first memory unit 14A in units of cache lines.

However, it has been conventionally difficult to efficiently provide information used to appropriately use the different types of storage units 14, that is, a memory access characteristic 42B of the processing circuit 12.

On the other hand, the information processing device 10 in the present embodiment derives the memory access characteristic 42B from the acquired operation statistical information 42A based on the prediction model 20, and determines any one of the first access method and the first access method.

Consequently, the information processing device 10 in the present embodiment can efficiently provide information used to appropriately use a plurality of different types of memories.

First Modification

In the above-mentioned embodiment, in the description of the procedure of the information processing, the configuration in which the changing unit 12F does not execute changing processing has been described as an example.

However, the changing processing may be executed by the changing unit 12F during the execution of the procedure of the information processing.

In this case, for example, after the first access method is chosen at Step S112 illustrated in FIG. 9, the changing unit 12F may execute changing processing for changing the available memory size of the first memory unit 14A. Next, the processing of Step S114 to Step S118 described above only needs to be executed.

Timing of the changing processing by the changing unit 12F is not limited to this timing. For example, the changing unit 12F may execute the changing processing after the first access method is chosen and data in the first area of the second memory unit 14B is transferred to the first memory unit 14A. The changing unit 12F may execute the changing processing after the first access method is chosen and data in the first area of the second memory unit 14B is transferred to the first memory unit 14A and further the execution unit 12E accesses the data in the first memory unit 14A.

Second Modification

In the above-mentioned embodiment, the configuration in which the determination unit 12D chooses the second access method when the memory access characteristic 42B derived by the derivation unit 12C is larger than the first threshold has been described. The configuration in which the determination unit 12D chooses the first access method when the memory access characteristic 42B is equal to or smaller than the first threshold has been described.

However, the determination unit 12D chooses the first access method or the second access method by another method.

For example, the determination unit 12D chooses the second access method when the ratio of memory access characteristic 42B is larger than a second threshold. The ratio of memory access characteristic 42B indicates a ratio (proportion) of the memory access characteristic 42B with respect to a total value of physical memory sizes allocated to one or more applications 32 running when operation indicated by operation statistical information 42A acquired by the acquisition unit 12A is executed.

Specifically, the determination unit 12D chooses the first access method when the ratio of the used memory size as the memory access characteristic 42B derived by the derivation unit 12C with respect to the total value of the physical memory sizes allocated to the running applications 32 is equal to or smaller than the second threshold.

The state in which the ratio is equal to or smaller than the second threshold indicates a state in which memory access concentrates on a partial area of the memory that can be used by the application 32. Thus, in this case, the determination unit 12D determines that the processing circuit 12 is accessing data having high access locality, and chooses the first access method for transferring data on the second memory unit 14B to the first memory unit 14A in units of pages (units of first areas) and accessing the data.

On the other hand, the determination unit 12D chooses the second access method when the ratio exceeds the second threshold.

The state in which the ratio exceeds the second threshold indicates a situation in which access by the processing circuit 12 to the entire memory area that can be used by the application 32 is distributed over the memory area. Thus, the state in which the ratio exceeds the second threshold is a state in which the locality of access is low and the used memory size is large. Thus, in this case, the determination unit 12D chooses the second access method.

As the second threshold, a desired value can be freely determined in advance. For example, the second threshold is 1/N (N is an integer of 2 or more) of the total value of the physical memory sizes allocated to one or more applications 32 described above. For example, the second threshold is a value of ⅓, ⅕, 1/7, or 1/10 of the above-mentioned total value. The basic concept is to select the first access method when speed-up commensurate with a DRAM used can be obtained. The reason is that it is preferred that speed-up of processing having high locality owing to the use of the DRAM be achieved while suppressing the increase in power consumption and cost due to the use of the DRAM by using about 1, 2, or 3of the DRAM when a physical memory size allocated to an application is 10.

Next, an example of a procedure of information processing executed by the processing circuit 12 when the determination unit 12D determines an access method by using the ratio is described.

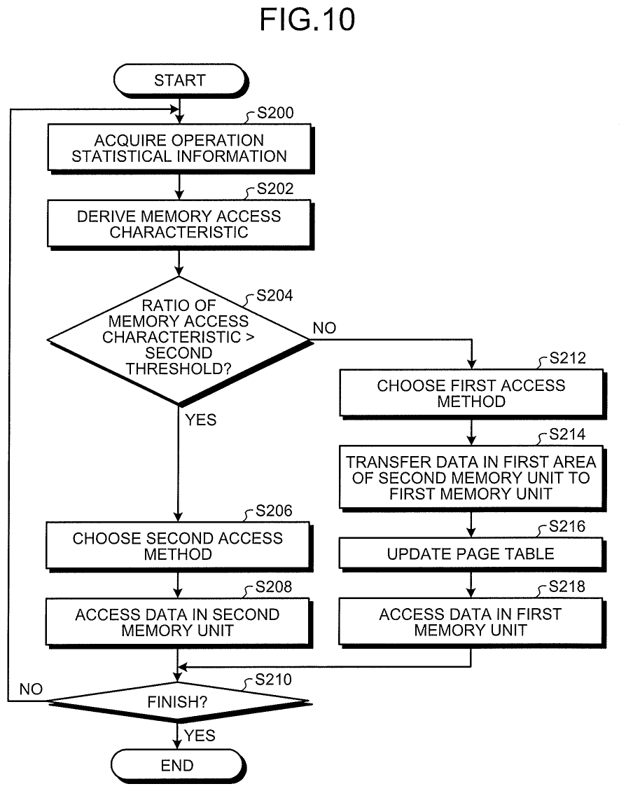

FIG. 10 is a flowchart illustrating an example of the procedure of the information processing executed by the processing circuit 12 in the present modification.

First, the processing circuit 12 executes processing of Step S200 to Step S202 similarly to Step S100 to Step S102 (see FIG. 9) in the above-mentioned embodiment.

Specifically, the acquisition unit 12A acquires operation statistical information 42A on the processing circuit 12 in a unit period T (Step S200). Next, the derivation unit 12C inputs the operation statistical information 42A acquired at Step S200 to a prediction model 20 learned by the learning unit 12B to derive a memory access characteristic 42B (Step S202).

Next, the determination unit 12D determines whether the ratio of the memory access characteristic 42B derived at Step S202 is larger than a second threshold (Step S204).

When the determination unit 12D determines that the ratio of the memory access characteristic 42B is larger than the second threshold (Yes at Step S204), the processing of Step S206, Step S208, and Step S210 similarly to Step S106 to Step S110 (see FIG. 9) in the above-mentioned embodiment.

On the other hand, when the determination unit 12D determines that the ratio of the memory access characteristic 42B is equal to or smaller than the second threshold (No at Step S204), the processing of Step S212 to Step S218 is executed similarly to Step S112 to Step S118 (see FIG. 9) in the above-mentioned embodiment. When positive determination is made at Step S210 (Yes at Step S210), this routine is finished.

As described above, the determination unit 12D may determine an access method by determining whether the ratio of the memory access characteristic 42B derived by the derivation unit 12C is larger than the second threshold. Also in this case, the same effects as in the above-mentioned embodiment are obtained.

In the above-mentioned embodiment and modifications, the configuration in which the information processing device 10 includes the processing circuit 12, the cache memory 16, and the management device 18 has been described as an example (see FIG. 1). However, the information processing device 10 may include the processing circuit 12, the cache memory 16, the management device 18, and the storage unit 14. The processing circuit 12 may include at least one of the cache memory 16 and the management device 18. The management device 18 may include the storage unit 14 and the cache memory 16.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a hardware processor configured to function as:
an acquisition unit configured to acquire operation statistical information on a processing circuit;
a derivation unit configured to derive a memory access characteristic of the processing circuit from the acquired operation statistical information, based on a prediction model for deriving the memory access characteristic from the operation statistical information; and
a determination unit configured to determine an access method from among a first access method and a second access method based on the derived memory access characteristic, the first access method transferring data in a second memory unit to a first memory unit and accessing the data in the first memory unit, the second access method accessing data in the second memory unit, an access speed of the second memory unit from the processing circuit being slower than that of the first memory unit.

2. The device according to claim 1, wherein the hardware processor is further configured to function as an execution unit configured to execute, in accordance with the determined access method, transfer of the data from the second memory unit to the first memory unit and access to the data in the first memory unit, or access to the data in the second memory unit.

3. The device according to claim 1, wherein the operation statistical information includes at least one of a physical memory size allocated to an application that is being executed by the processing circuit, and operation statistical information related to a translation lookaside buffer (TLB) miss.

4. The device according to claim 1, wherein the memory access characteristic indicates a memory size used by the processing circuit per unit period.

5. The device according to claim 4, wherein the determination unit chooses the second access method when the derived memory access characteristic is larger than a first threshold, and chooses the first access method when the memory access characteristic is equal to or smaller than the first threshold.

6. The device according to claim 5, wherein the first threshold is a value equal to or larger than a size of the first memory unit available to the processing circuit.

7. The device according to claim 1, wherein the determination unit chooses the second access method when a ratio of the memory access characteristic with respect to a total value of physical memory sizes allocated to one or more applications related to the acquired operation statistical information is larger than a second threshold, and chooses the first access method when the ratio is equal to or smaller than the second threshold.

8. The device according to claim 7, wherein the second threshold is 1/N of the total value (N is an integer of 2 or more).

9. The device according to claim 1, wherein the hardware processor is further configured to function as a changing unit configured to change an available memory size of the first memory unit when the first access method is chosen.

10. The device according to claim 1, wherein the hardware processor is further configured to function as a learning unit configured to learn the prediction model by using a training data set including a plurality of pieces of training data indicating correspondence between the operation statistical information and the memory access characteristic.

11. The device according to claim 10, wherein the training data indicates correspondence between the operation statistical information and the memory access characteristic for each instruction unit of an application.

12. The device according to claim 11, wherein the learning unit executes an application for learning at least twice, acquires the operation statistical information in first execution of the application, acquires the memory access characteristic in second execution of the application, and generates, for each instruction unit of the application, the training data indicating correspondence between the acquired operation statistical information and the acquired memory access characteristic.

13. An information processing method comprising:
acquiring operation statistical information on a processing circuit;
deriving a memory access characteristic of the processing circuit from the acquired operation statistical information, based on a prediction model for deriving the memory access characteristic from the operation statistical information; and
determining an access method from among a first access method and a second access method based on the derived memory access characteristic, the first access method transferring data in a second memory unit to a first memory unit and accessing the data in the first memory unit, the second access method accessing data in the second memory unit, an access speed of the second memory unit from the processing circuit being slower than that of the first memory unit.

14. A computer program product comprising a computer-readable medium including programmed instructions, the instructions causing a computer to execute:
acquiring operation statistical information on a processing circuit;
deriving a memory access characteristic of the processing circuit from the acquired operation statistical information, based on a prediction model for deriving the memory access characteristic from the operation statistical information; and
determining an access method of a first access method and a second access method based on the derived memory access characteristic, the first access method transferring data in a second memory unit to a first memory unit and accessing the data in the first memory unit, the second access method accessing data in the second memory unit, an access speed of the second memory unit from the processing circuit being slower than that of the first memory unit.
